(19) United States
(12) Patent Application Publication
(10) Pub. No.: US 2025/0050362 A1
(43) Pub. Date: Feb. 13, 2025

(54) CONTAINER WITH INSET NECK AND DISCREET PUMP ASSEMBLY

(71) Applicant: MONDAY INTERNATIONAL LIMITED, KOWLOON (HK)

(72) Inventor: Mathew Peter MOWBRAY, Coatesville (NZ)

(21) Appl. No.: 18/720,786

(22) PCT Filed: Dec. 22, 2021
(86) PCT No.: PCT/SG2021/050817

§ 371 Date: Jun. 17, 2024

(51) Int. Cl. B05B 11/00; B05B 11/10

(52) U.S. Cl. CPC B05B 11/0037; B05B 11/1047; B05B 11/106

(57) ABSTRACT

A container comprising concavity in which a container neck is situated, inset from the top of the container, such that a pump assembly may be fastened to said inset neck resulting in a more discreet form, a container design that is less overpowered by protruding a protruding pump, and a more volume-efficient assembly. Additionally, space between the pump assembly and a peripheral wall of said concavity is reserved such that an annular wall of a pump head may move within said space when the pump head is pressed to dispense the contents of the container.

### TECHNICAL FIELD

This invention relates to the field of moulded plastic containers, particularly liquid or gel-containing bottles comprising a hand pump mechanism.

### BACKGROUND

Plastic containers are the primary apparatus used in modern storage of consumer goods, for both reusable containers and single-use containers. Reusable containers are generally sold as empty containers, while single-use containers may be transported containing product across various categories; this may include food, beverage, cosmetics, pharmaceutical, and may also comprise various types of mediums such as solids, powders, liquids, gels, pastes. Additionally, plastic containers may have simple openings to retrieve the contents by hand or with a utensil, or they may also have integrated functionality for deposition such as measuring cups, hand operated pumps, or squeeze operated bodies to dispense the contents from a nozzle or hole.

In the case where a plastic container comprises an external mechanism, such as a pump to aid in deposition of the contents, the external volume of the container is increased; with a reusable container such a mechanism may be able to be stored inside the empty container during transport, however, with a single-use container, the pump would be already assembled. Pumps on plastic containers are generally transported in a depressed position, however this only partially reduces the volume added to the exterior of the container.

Furthermore, plastic containers comprising large, protruding pumps, or other deposition mechanisms, are often affected in terms of design freedom since accommodating the deposition mechanism can force a certain form.

Given these disadvantages of inefficient volume-use affecting economical transport and protruding features such as pumps affecting product design of current plastic containers, therein exists a need for a plastic container that may comprise externally fastened components that are mounted to be more space efficient and reduce common visual disruptions such that the design of the container is less overpowered by said components.

### SUMMARY OF THE INVENTION

Accordingly, in a first aspect, the present invention comprises a container with an annular neck that is inset within a concavity, wherein the concavity comprises a peripheral surface, which extends downward from a top surface of the container, and an inset surface that forms the bottom of the concavity, with the neck protruding from the inset surface and comprising a hole that leads into the internal volume of the container. Furthermore, the present invention comprises a hand-operated pump assembly that may be actuated to transition its pump head from a neutral position to a pressed position to dispense the contents of the container; the pump assembly mates to the inset neck, wherein the pump assembly itself is seated in a position partially inset from the top of the container, providing a more discreet pump assembly consequently reducing its volumetric and visual impact.

It is an additional objective of this invention that the inset neck of the container comprises a thread in which the pump assembly may fasten to.

It is also an additional objective of this invention that the pump head of the pump assembly comprises an annular wall that, when transitioning to the pressed position, may move within a space between the peripheral wall of the concavity and the inset neck of the container.

Furthermore, it is an additional objective of this invention that when the pump head is in the neutral position, the annular wall of the pump head is at least partially between the top surface and the inset surface.

It is also an additional objective of this invention that a contour shape of the peripheral wall is substantially similar to a contour shape of the annular wall of the pump head.

Preferably, for instance, if the contour shape of the peripheral wall is circular, the contour shape of the annular wall of the pump head should be circular, such that the pump head may be concentric to the peripheral wall and there is a minimal amount of space between the relevant surfaces, improving the seamless transition between the container and pump assembly, and reducing wasted volume.

It is an additional objective of this invention that the container is made of a PET polymer.

Furthermore, it is an additional objective of this invention that the container is formed using a blow moulding process.

Furthermore, it is an additional objective of this invention that the container is formed using a preform for said blow moulding process.

Furthermore, it is an additional objective of this invention that the container comprises a single internal volume, and does not comprise baffles within said internal volume, such that the container does not comprise independent cavities or augmented sectors within a single internal space.

It is also an additional objective of this invention that when the pump assembly is in the neutral position, a first distance d1 is defined between an uppermost surface of the pump head and the top surface of the container, and wherein d1 is 20 mm to 50 mm.

It is also an additional objective of this invention that when the pump assembly is in the pressed position, a second distance d2 is defined between an uppermost surface of the pump head and the top surface of the container, and wherein d2 is 10 mm to 30 mm.

In a second aspect, the present invention comprises a container comprising an inset neck, such that the inset neck is at least partially below a top surface of the container. Furthermore, the present invention comprises a pump assembly, wherein the pump assembly may fasten to the inset neck of the container.

It is also an additional objective of this invention that the inset neck and the pump assembly each comprise a corresponding thread, such that the pump assembly may mate to the inset neck.

It is also an additional objective that the pump assembly comprises a pump head that may be depressed to actuate the pump assembly.

It is also an objective of this invention that when said pump head is depressed, the pump head translates at least partially below the top surface of the container.

It is an additional objective of this invention that the container is made of a PET polymer.

Furthermore, it is an additional objective of this invention that the container is formed using a blow moulding process.

Furthermore, it is an additional objective of this invention that the container is formed using a preform for said blow moulding process.

Furthermore, it is an additional objective of this invention that the container comprises a single internal volume, and does not comprise baffles within said internal volume, such that the container does not comprise independent cavities or augmented sectors within a single internal space.

Additional features and advantages of the invention will be set forth in the description which follows, and in part will be apparent from the description, or may be learned by practice of the invention. The objectives and other advantages of the invention will be realised and attained by the structure particularly pointed out in the written description and claims hereof as well as the appended figures.

It is to be understood that both the foregoing general description and the following detailed description are exemplary and explanatory and are intended to provide further explanation of the invention as claimed.

### DESCRIPTION OF THE DRAWINGS

The accompanying drawings, which are included to provide further understanding of the invention are incorporated and constitute a part of this specification, illustrate embodiments of the invention and together with the description, serve to explain the principles of the invention.

In the drawings:

FIG. 1 displays a three-quarter perspective view of the present embodiment of the invention.

FIG. 2 shows a side view of the present embodiment.

FIG. 3 shows a three-quarter perspective view of the container of the present embodiment.

FIG. 4 shows a cross-sectional three-quarter perspective view of the container of FIG. 3.

FIG. 5 shows a side view of the pump assembly of the present embodiment.

FIG. 6 shows a cross-sectional side view of the pump assembly of FIG. 5.

FIG. 7 shows a cross-sectional side view of the present embodiment with the pump head in a neutral position.

FIG. 8 shows a cross-sectional side view of the present embodiment with the pump head in a pressed position.

### DETAILED DESCRIPTION OF THE INVENTION

As mentioned hereinbefore or after, when referring to a pump or pump assembly of a corresponding container, ‘pump’ refers to a manually actuated pump, such as a hand-pump, wherein the pump is a mechanical pump and does not comprise any electronics. Furthermore, the pump assembly may comprise additional components in addition to the core pump mechanism, such as fastening aids, nozzles, caps, pump heads, and inlet tubes.

The invention as disclosed in its current form comprises of: A container with an inset neck and a pump assembly. The pump assembly is fastened to said inset neck such that a pump head is partially inset providing a pump assembly that minimally protrudes beyond a top surface of the container.

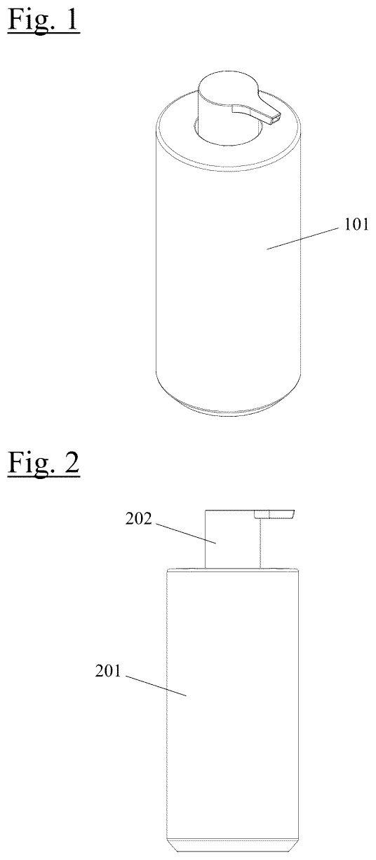

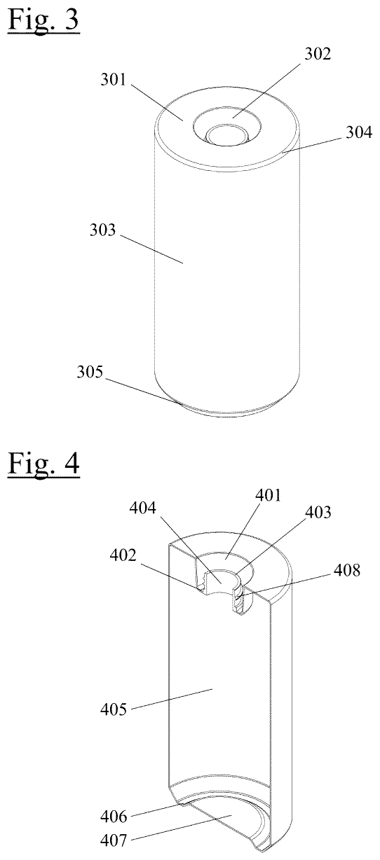

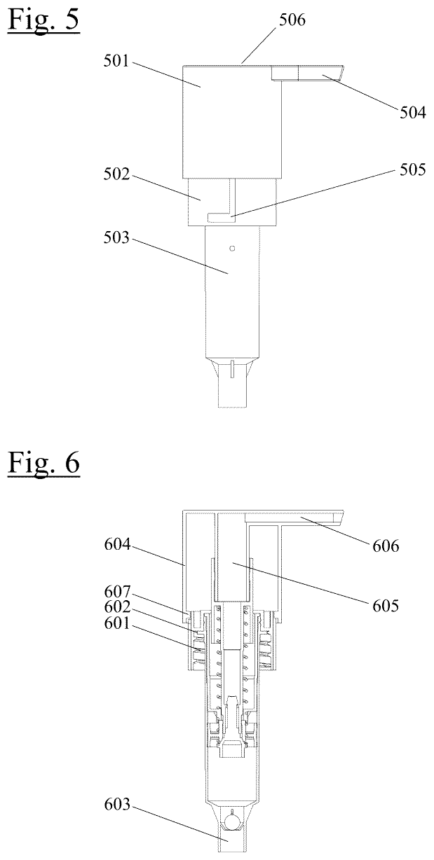

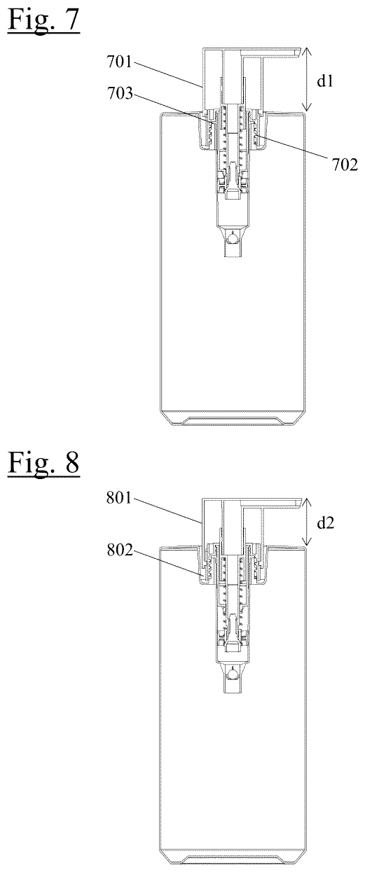

Referring now to FIGS. 1 to 6, a preferred embodiment 101 of the invention may be seen; it comprises a container 201 and a pump assembly 202. The top surface 301 of the container comprises a concavity 302 in its centre, with the concavity comprising a peripheral surface 401, an inset surface 402, and an annular neck 403 that extends upward from the inset surface 402. The annular neck 403 comprises hole 404 that leads into the internal volume 405 of the container, and a male thread 408 that the pump assembly can mount to. The container is a cylindrically shaped container, with common features such as a cylindrical side surface 303, a chamfered top edge 304 and a chamfered bottom edge 305, and the bottom of the container comprising a raised portion 407 and a lowered portion 406 to provide better balance.

The pump assembly 202 in the present embodiment comprises three key sub-parts: the pump head 501, the mounting cap 502, and the pump cartridge 503. The pump head 501 comprises an uppermost surface 506, a nozzle 504 and an annular wall 604, wherein the nozzle comprises an internal nozzle bore 606 that transitions to an annular nozzle bore mount 605 that may mount to the pump cartridge 503. The mounting cap 502 comprises a female thread 601 such that the mounting cap sits on top of the pump cartridge 503 and fastens (702) to the male thread 408 of the annular neck 403 constraining a flange 602 of the pump cartridge on a seating surface 703 on top of the annular neck 403. The pump cartridge comprises a tube mount 603 such that a tube may be connected to extend toward the bottom of the container, wherein the contents of the container may be pumped through the pump cartridge, into the nozzle bore 606, and out the tip of the nozzle 504.

The pump assembly as described in this embodiment exists as an example of a possible implementation of a hand pump, however, it should be understood that the spirit of the invention, being the form of the inset neck from the top surface 301 allowing a partially inset pump assembly, does not depend on the inner workings of the paired pump assembly; consequently, alternative embodiments may include alternative pump assembly designs, and/or mechanisms, such as spray pumps, foaming pumps, pump heads with no nozzle extension, and even pump assemblies that comprise a male thread such that the container's annular neck 403 comprises a corresponding female thread. Moreover, it should be understood that the inset neck of the invention may act as a feature that allows many possible unique pump assembly designs to take advantage of the inset neck, thus the present design of the pump assembly 202 should not limit or dictate any alternative embodiments to conform to a particular design, rather that alternative embodiments may comprise any symbiotic pump assembly that benefits from the invention.

When the pump assembly 202 is fastened to the container 201, the pump head 501 may be pressed to move from a neutral position 701 to a pressed position 801 consequently actuating the pump cartridge 503 to pump the contents of the container 201 through the nozzle bore 606 and out the tip of the nozzle 504. To allow this movement, there is a space 802 between the mounting cap 502 and the peripheral surface 401 that the annular wall 604 may move within. According to certain optional embodiments, the space 802 is 3 mm to 10 mm, radially around the mounting cap 502. In this embodiment, when the pump head 501 is in either of both said positions 701 801, the bottom of the annular wall 604 is below a topmost point of the peripheral surface 401 of the container 201; this provides a more homogenous appearance of the pump assembly 202 being inset and apart of the container 201 rather than a separate protruding feature, regardless of the positional state of the pump head 501, due to any obvious sightlines into where the pump assembly 202 fastens to the container 201 being obscured by the pump head 501 extending below the peripheral surface 401. According to further optional embodiments, when in the neutral position 701, a first distance d1 is defined between the uppermost surface 506 of the pump head 501 and the top surface 301 of the container 201. The first distance d1 is optionally 20 mm to 50 mm. According to further optional embodiments, when in the pressed position 801, a second distance d2 is defined between the uppermost surface 506 of the pump head 501 and the top surface 301 of the container 201. The second distance d2 is optionally 10 mm to 30 mm. By providing the distances d1 and d2 within the abovementioned range, the goals of external volume efficiency and integrated design appearance are both well-achieved, yet well balanced with the effective operation of the pump assembly.

Furthermore, the mounting cap 502 comprises locking channels 505 moulded into its outer surface that protrusions 607 from the pump head interface with such that when the pump head 501 is in the pressed position 801 it may be rotated about its central axis and lock the pump head to prevent it from returning to its neutral position 701; this ensures that the present embodiment is at its most minimal size when the pump is locked from operating, which saves volume when this is necessary such as during transport and shipping.

In the current embodiment of the invention, and most alternative embodiments, it should be expected that the pump assembly 202 comprises a positive displacement pump mechanism, however, the scope of the invention does not particularly limit said pump assembly to exclusively comprise a positive displacement mechanism.

The invention as described may be possible to be manufactured using various techniques, however with the present embodiment of the invention, it is preferable that the container 201 is made of PET and is formed by blow moulding, with the blow moulding using a preform such that the annular neck 403 and its thread 408 is pre-formed.

Furthermore, in this embodiment, it is preferable that the container 201 is formed to comprise a single internal volume. In alternative embodiments a container may be formed with an annular neck on a top surface, and a secondary set of surfaces formed on top of the container to obfuscate said annular neck; it should be noted, however, that said alternative embodiment does not effectively utilise the potential volume of the entire container, with the secondary set of surfaces not contributing to the internal volume of the container that the annular neck provides access to.

Additionally, in alternative embodiments of the invention, it may be preferable that the inset neck of the container and the mounting cap of the pump assembly both do not comprise a corresponding thread in which they may be fastened to one another, instead alternative fastening methods may be used such as a clip, a friction fit, a cam fit, a snap fit, a barb, or other preferable mounting mechanisms.

The invention has been described with examples relevant to its current form, however, potential embodiments will include any form that is within the scope of the appended claims. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An article comprising:
a container comprising a concavity on a top surface,
wherein the concavity comprises an annular neck, an inset surface, and a peripheral surface,
wherein the peripheral surface extends in a first direction away from the top surface,
wherein the annular neck extends toward the top surface, and
wherein the annular neck comprises a first hole that provides access to an internal volume of the container; and
a pump assembly that is configured to mate to the annular neck,
wherein at least a portion of the pump assembly extends into the first hole,
wherein the pump assembly comprises a pump head that is configured to selectively transition from a neutral position to a pressed position to actuate the pump assembly.

2. The article of claim 1, wherein the annular neck of the container comprises a first thread and the pump assembly comprises a mounting cap comprising a second thread, wherein the pump assembly is configured to mate to the container by engagement of the first thread to the second thread.

3. The article of claim 1, wherein the pump head comprises an annular wall, wherein when the pump head is in the pressed position at least a portion of the annular wall is is positioned between the annular neck and the peripheral surface and between the top surface and the inset surface.

4. The article of claim 1, wherein when the pump head is in the neutral position at least a portion of the annular wall is between the annular neck and the peripheral surface and the top surface and the inset surface.

5. The article of claim 3, wherein a contour shape of the peripheral surface of the container is substantially similar to a contour shape of the annular wall of the pump head.

6. The article of claim 1, wherein the container is made of polyethylene terephthalate (PET).

7. The article of claim 1, wherein the container is formed by a blow molding process.

8. The article of claim 7, wherein the blow molding process includes a preform.

9. The article of claim 1, wherein the container comprises defines only one internal volume.

10. The article of claim 1, wherein when the pump head is in the neutral position, a first distance between an uppermost surface of the pump head and the top surface of the container is between 20 mm to 50 mm.

11. The article of claim 1, wherein when the pump head is in the pressed position, a second distance between an uppermost surface of the pump head and the top surface of the container is between 10 mm to 30 mm.

12-19. (canceled)

20. The article of claim 2, wherein the first thread is a male thread configuration and the second thread is a female thread configuration.

21. The article of claim 1, wherein the pump assembly comprises the pump head, a mounting cap, and a pump cartridge.

22. The article of claim 1, wherein the pump head comprises an annular wall, wherein a bottom of the annular wall is below a topmost point of the peripheral surface in both the neutral position and the pressed position.

23. The article of claim 1, wherein the pump assembly comprises a positive displacement pump mechanism.

24. The article of claim 1, wherein the pump assembly is configured to mate to the annular neck by a clip, a friction fit, a cam fit, a snap fit, or a barb.
